(19) United States
(12) Patent Application Publication
(10) Pub. No.: US 2012/0224287 A1
(43) Pub. Date: Sep. 6, 2012

(54) FUZZY INTERFERENCE RELAY AND METHOD FOR CURRENT DIFFERENTIAL PROTECTION OF A TRANSMISSION LINE

(75) Inventors: Waldemar Rebizant, Wroclaw (PL); Krzysztof Solak, Miekinia (PL); Andrzej Wiszniewski, Wroclaw (PL); Andrzej Klimek, Surrey (CA)

(73) Assignees: Schneider Electric Energy UK Ltd., Telford (GB); Alstom Technology Ltd., Baden (CH)

(21) Appl. No.: 13/509,983

(22) PCT Filed: Nov. 17, 2009
(86) PCT No.: PCT/EP09/65340

§ 371 Date: May 15, 2012

(51) Int. Cl. H02H 3/26

(52) U.S. Cl. 361/76

(57) ABSTRACT

A relay for current differential protection of a transmission line, comprising: a first calculator of symmetrical sequence components of currents of each phase of the transmission line at local and remote ends of the transmission line; a second calculator of phase differences φ₁₂ and φ₀₁₂ between combinations currents i₁₂ and i₀₁₂ of the symmetrical sequence currents; a fuzzy inference system which outputs a variable y whose value is calculated according to the values of the phase differences φ₁₂ and φ₀₁₂; a third calculator which outputs a tripping signal for the control of a circuit breaker arranged on the transmission line and associated with the relay, the value of the tripping signal being calculated according to the values of the variable y and the values of the currents of each phase at the local and remote ends of the protected transmission line.

### TECHNICAL FIELD OF THE INVENTION

The invention relates to the protection of a transmission line using current measurements obtained with measurements transducers of the current transformer type.

The invention also concerns transmission line protection systems, and more specifically, current differential protection relay and method for power transmission lines.

The invention also concerns a method for operating a current differential protection relay electrically coupled to a protection zone of an electrical power transmission line, methods for protecting a zone of a transmission line having current differential protection relays coupled thereto, and a current differential protection relay.

The protection zone may include parts of a transmission line having two terminal ends.

### PRIOR ART

A current differential protection system uses only the electrical currents values information obtained from the protected line. Current differential protection requires a comparison of the currents entering and leaving a protected zone of the line. An example of a current differential protection system of an electrical transmission line is represented on FIG. 1. Protective relays 2, 4 are located at each end of a protected line 1. Such system may provide phase-segregated current differential protection. Circuit breakers 6, 8 and current transformers (CT) 7, 9 are associated, respectively, with relays 2, 4. A communication between the relays 2, 4 is made by a communication line 10.

In operation, each current transformer 7, 9 measures line current values at each ends of the protected line 1, and transmits those values to its associated relay. Each relay 2, 4 transmits those values to the relay located at the other end of the line 1, for each phase of the transmission line 1. Thus, for each phase, the relay 2 will combine the current value iₛ given by the current transformer 7 with the line current values iᵣ sent from the remote relay, that is the relay 4, and transmitted on the communication line 10. The sum of the current values is zero (iₛ+iᵣ=0) when an external fault appears (for example on an external line 12), while internal faults (on the protected line 1, between the relays 2, 4) will result in a non-zero combined currents ((iₛ+iᵣ≠0). Moreover, the sum of the currents values is equal to zero when there is no fault, neither on the external line 12 nor on the protected line 1.

Each relay 2, 4 controls its associated circuit breaker 6, 8 according to a stabilization function in form of an appropriate diff-bias characteristic which represents the tripping conditions of the circuit breakers 6, 8 associated with the relays 2, 4. The use of such a diff-bias characteristic prevents relays from undesired line tripping due to differential current resulting from not fully compensated charging current, CT errors, etc. A corresponding diff-bias characteristic is shown on FIG. 2. According to this characteristic, the trip criteria are:

for |i_{bias}<I_{S2}, tripping when |i_{diff}|>|k₁|i_{bias}|+I_{S1};

for |i_{bias}|>I_{S2}, tripping when |i_{diff}|>k₂|i_{bias}−(k₂−k₁)I_{S2}+I_{S1};

with:

|i_{bias}|=0.5(|iₛ|+|iᵣ|);

|i_{diff}|=|iₛ+iᵣ|;

k₁, k₂: bias percentages.

The values of Iₛ₁, Iₛ₂, k₁ and k₂ are chosen arbitrarily according to the characteristics of the line to be protected and the desired protection type.

Although for most cases this standard protection arrangement is sufficient, there are still cases when the protection may fail, especially for external faults with severe CT saturation due to decaying DC components in fault currents with long time constant.

### DESCRIPTION OF THE INVENTION

Thus there is a need for an improved protection of the transmission lines with improved stabilization for external fault cases, yet with maintained sensitivity and operation speed for internal faults requiring prompt tripping.

One embodiment of the invention proposes a relay for current differential protection of at least one transmission line, comprising at least:

a first calculator of symmetrical sequence currents, or symmetrical sequence components, which include zero sequence currents i₀, positive sequence currents i₁ and negative sequence currents i₂, of currents of each phase of the transmission line at local and remote ends of the protected transmission line;

a second calculator of phase differences φ₁₂ and φ₀₁₂ between combination currents i₁₂ and i₀₁₂ of the symmetrical sequence currents i₀, i₁ and i₂ of each ends of the transmission line;

a fuzzy inference system which outputs a variable y whose value is calculated according to the values of the phase differences φ₁₂ and φ₀₁₂;

a third calculator which outputs a tripping signal for the control of at least one circuit breaker arranged on the transmission line and associated with the relay, the value of the tripping signal being calculated according to the values of the variable y and the values of the currents of each phase of the transmission line at the local and remote ends of the protected transmission line.

Such current differential protection enables better tripping performances, particularly for cases of external faults with severe CT saturation, when traditional current differential protection may maloperate. It avoids unwanted tripping of healthy transmission line, which may endanger stability of the global power system, especially when the protected line is heavily loaded.

The current differential protection according to the invention combines strengths of both currents magnitude and phase values comparison criteria. The value of the tripping signal, which may correspond to a relay stabilization characteristic, is adapted according to the value of the output of the fuzzy inference system which applies fuzzy logic on phase differences of sequence currents combinations. Such adaptive stabilization characteristic improves current differential protection performances and ensures higher robustness, in particular for cases of external faults with CT saturation.

The combination currents i₁₂ and i₀₁₂ may be such that:

i₁₂=i₂−k_{1g}i₁,

i₀₁₂=k₂ₚi₂+k_{1g}(i₁+i₀);

with k_{1g}=k₂ₚ=0 when the current amplitude in each phase is higher than or equal to around 1.5 per unit in any phase, and k_{1g} and k₂ₚ being non-zero real numbers otherwise.

The fuzzy inference system may comprise at least:

a fuzzyfication unit which may convert the values of the phase differences φ₁₂ and φ₀₁₂ into fuzzy variables μ(φ₁₂) and μ(φ₀₁₂);

an inference operation unit which may perform inference operation on fuzzy variables μ(φ₁₂) and μ(φ₀₁₂) according to a fuzzy rules base and may outputs final fuzzy sets μ(y) as a result of said inference operation;

a defuzzyfication unit which may convert the final fuzzy sets μ(y) into the variable y by a defuzzyfication operation.

In this case, the fuzzyfication unit may convert the phase difference φ₁₂ into the fuzzy variable μ(φ₁₂) such that:

when the value of φ₁₂ is included between 0° and 75°, μ(φ₁₂) may be “Low” with a value equal to 1 and “High” with a value equal to 0;

when the value of φ₁₂ is included between 80° and 180°, μ(φ₁₂) may be “Low” with a value equal to 0 and “High” with a value equal to 1;

when the value of φ₁₂ is included between 75° and 80°, μ(φ₁₂) may be “Low” with a value equal to

$$1 - \frac{{ϕ}_{12} - 75}{5}$$

and “High” with a value equal to

$$\frac{{ϕ}_{12} - 75}{5} .$$

The fuzzyfication unit may convert the phase difference φ₀₁₂ into the fuzzy variable μ(φ₀₁₂) such that:

when the value of φ₀₁₂ is included between 0° and 75°, μ(φ₀₁₂) may be “Low” with a value equal to 1 and “High” with a value equal to 0;

when the value of φ₀₁₂ is included between 85° and 180°, μ(φ₀₁₂) may be “Low” with a value equal to 0 and “High” with a value equal to 1;

when the value of φ₀₁₂ is included between 75° and 85°, μ(φ₁₂) may be “Low” with a value equal to

$$1 - \frac{{ϕ}_{012} - 75}{10}$$

and “High” with a value equal to

$$\frac{{ϕ}_{012} - 75}{10} .$$

The inference operation unit may perform the inference operation according to the following fuzzy rules base:

IF φ₀₁₂ is “High” AND φ₁₂ is “High” THEN y is “L”;

IF φ₀₁₂ is “Low” AND φ₁₂ is “High” OR φ₀₁₂ is “High” AND (P₁₂ is “Low” THEN y is “M”;

IF φ₀₁₂ is “Low” AND φ₁₂ is “Low” THEN y is “H”;

with “L”, “M” and “H” which are singletons corresponding to output values 0, 1 and 2 respectively.

The logical functions “AND” and “OR” of the fuzzy rules base may correspond to operators “Product” and “Maximum” respectively.

The defuzzyfication operation may be a weighting factor method, the resulting output value y may be expressed by:

$$y = \frac{{μ}_{L} {y}_{L} + {μ}_{M} {y}_{M} + {μ}_{H} {y}_{H}}{{μ}_{L} + {μ}_{M} + {μ}_{H}} ,$$

with

μ_{L}=1 when y=0, and μ_{L}=0 otherwise;

μ_{M}=1 when y=1, and μ_{M}=0 otherwise;

μ_{H}=1 when y=2, and μ_{L}=0 otherwise.

The third calculator may calculate values of bias percentages k₁ and k₂ of a stabilized characteristic which corresponds to the tripping signal such that:

k₁=0.3 +0.8y when the parameter y is higher than around 1.5, and k₁=0.3 otherwise;

k₂=1.5+1.6y;

the tripping conditions of the circuit breaker being:

for |i_{bias}|<I_{S2}, tripping when |i_{diff}|>k₁|i_{bias}+I_{S1};

for |i_{bias}|>I_{S2}, tripping when |i_{diff}|>k₂|i_{bias}|−(k₂−k₁)I_{S2}+I_{S1};

with, for each phase of the transmission line:

|i_{bias}|=0.5(|iₛ|+|iᵣ|) and

|i_{diff}|=|iₛ+iᵣ|, with

iₛ: current at the local end of the protected transmission line;

iᵣ: current at the remote end of the protected transmission line;

I_{S1}, I_{S2}: non-zero positive real numbers.

Another embodiment of the present invention concerns a current differential protection method of at least one transmission line, comprising at least the steps of:

calculating symmetrical sequence currents, which include zero sequence currents i₀, positive sequence currents i₁ and negative sequence currents i₂, of currents of each phase of the transmission line at local and remote ends of the protected transmission line;

calculating phase differences φ₁₂ and φ₀₁₂ between combination currents i₁₂ and i₀₁₂ of the symmetrical sequence currents i₀, i₁ and i₂ of each ends of the transmission line;

applying a fuzzy inference method on the phase differences φ₁₂ and φ₀₁₂ which output a variable y whose value is calculated according to the values of the phase differences φ₁₂ and φ₀₁₂;

calculating a value of a tripping signal for the control of at least one circuit breaker arranged on the transmission line according to the values of the variable y and the values of the currents of each phase of the transmission line at the local and remote ends of the protected transmission line.

The fuzzy inference method may comprise at least the steps of:

fuzzyfication operation which may convert the values of the phase differences φ₁₂ and φ₀₁₂ into fuzzy variables μ(φ₁₂) and μ(φ₀₁₂);

inference operation on fuzzy variables μ(φ₁₂) and μ(φ₀₁₂) according to a fuzzy rules base to output final fuzzy sets μ(y);

defuzzyfication operation which may convert the final fuzzy sets μ(y) into the variable y.

The fuzzyfication operation may convert the phase difference φ₁₂ into the fuzzy variable μ(φ₁₂) such that:

when the value of φ₁₂ is included between 0° and 75°, μ(φ₁₂) may be “Low” with a value equal to 1 and “High” with a value equal to 0;

when the value of φ₁₂ is included between 80° and 180°, μ(φ₁₂) may be “Low” with a value equal to 0 and “High” with a value equal to 1;

when the value of φ₁₂ is included between 75° and 80°, μ(φ₁₂) may be “Low” with a value equal to

$$1 - \frac{{ϕ}_{12} - 75}{5}$$

and “High” with a value equal to

$$\frac{{ϕ}_{12} - 75}{5} .$$

The fuzzyfication operation may convert the phase difference φ₀₁₂ into the fuzzy variable μ(φ₀₁₂) such that:

when the value of φ₀₁₂ is included between 0° and 75°, μ(φ₀₁₂) may be “Low” with a value equal to 1 and “High” with a value equal to 0;

when the value of φ₀₁₂ is included between 85° and 180°, μ(φ₀₁₂) may be “Low” with a value equal to 0 and “High” with a value equal to 1;

when the value of φ₀₁₂ is included between 75° and 85°, μ(φ₁₂) may be “Low” with a value equal to

$$1 - \frac{{ϕ}_{012} - 75}{10}$$

and “High” with a value equal to

$$\frac{{ϕ}_{012} - 75}{10} .$$

The inference operation may be performed according to the following fuzzy rules base:

IF φ₀₁₂ is “High” AND φ₁₂ is “High” THEN y is “L”;

IF φ₀₁₂ is “Low” AND φ₁₂ is “High” OR φ₀₁₂ is “High” AND φP₁₂ is “Low” THEN y is “M”;

IF φ₀₁₂ is “Low” AND φ₁₂ is “Low” THEN y is “H”;

with “L”, “M” and “H” which are singletons corresponding to output values 0, 1 and 2 respectively.

The values of bias percentages k₁ and k₂ of a stabilized characteristic which corresponds to the tripping signal may be calculated such that:

k₁=0.3+0.8y;

k₂=1.5+1.6y;

the tripping conditions of the circuit breaker being:

for |i_{bias}|<I_{S2}, tripping when |i_{diff}|>k₁|i_{bias}|+I_{S1};

for |i_{bias}|>I_{S2}, tripping when |i_{diff}|>k₂|i_{bias}|−(k₂−k₁)I_{S2}+I_{S1};

with, for each phase of the transmission line:

|i_{bias}|=0.5(|iₛ|+|iᵣ|) and

|i_{diff}|=|iₛ+iᵣ|, with

iₛ: current at the local end of the protected transmission line;

iᵣ: current at the remote end of the protected transmission line;

I_{S1}, I_{S2}: non-zero positive real numbers.

The invention also concerns a current differential protection system comprising at least two relays as above described, each being coupled to one end of a transmission line and linked to each other with communication means.

The values of the currents at the local and remote ends of the transmission line may be measured by measurement transducers, for example current transformers arranged on each ends of the transmission line.

The invention also concerns a method of operating a current differential protection relay electrically coupled to a transmission line, said method comprising the execution of a current differential protection method as above described.

### BRIEF DESCRIPTION OF THE DRAWINGS

This invention will be better understood upon reading the description of exemplary embodiments given for purely illustrative and non-limiting purposes, with reference to the appended drawings, in which:

FIG. 1 shows a current differential protection system of a electrical transmission line of the prior art;

FIG. 2 shows a stabilization function of a current differential protection relay;

FIG. 3 shows a current differential protection system for a two ends transmission line, according to a particular embodiment of the invention;

FIG. 4 shows a relay, according to a particular embodiment of the invention, of a current differential protection system;

FIG. 5 shows a block diagram of a fuzzy inference system of a relay, according to a particular embodiment of the invention;

FIG. 6 shows trapezoidal membership functions used by a fuzzyfication unit of a fuzzyfication inference system of a relay, according to a particular embodiment of the invention;

FIG. 7 shows final fuzzy sets got with an inference operation unit of a fuzzyfication inference system of a relay, according to a particular embodiment of the invention.

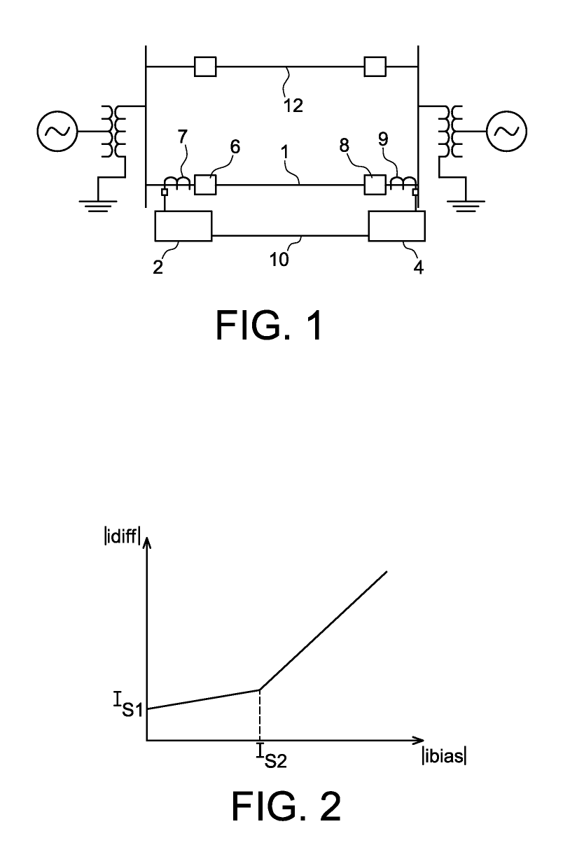

Identical, similar or equivalent portions of the figures described below bear the same numeric references so as to facilitate moving from one figure to another.

The various portions shown in the figures are not necessarily shown according to one uniform scale, in order to render the figures more legible.

The various possibilities (alternatives and embodiments) should be understood as not being mutually exclusive and can be combined with one another.

### DETAILED DESCRIPTION OF PARTICULAR EMBODIMENTS

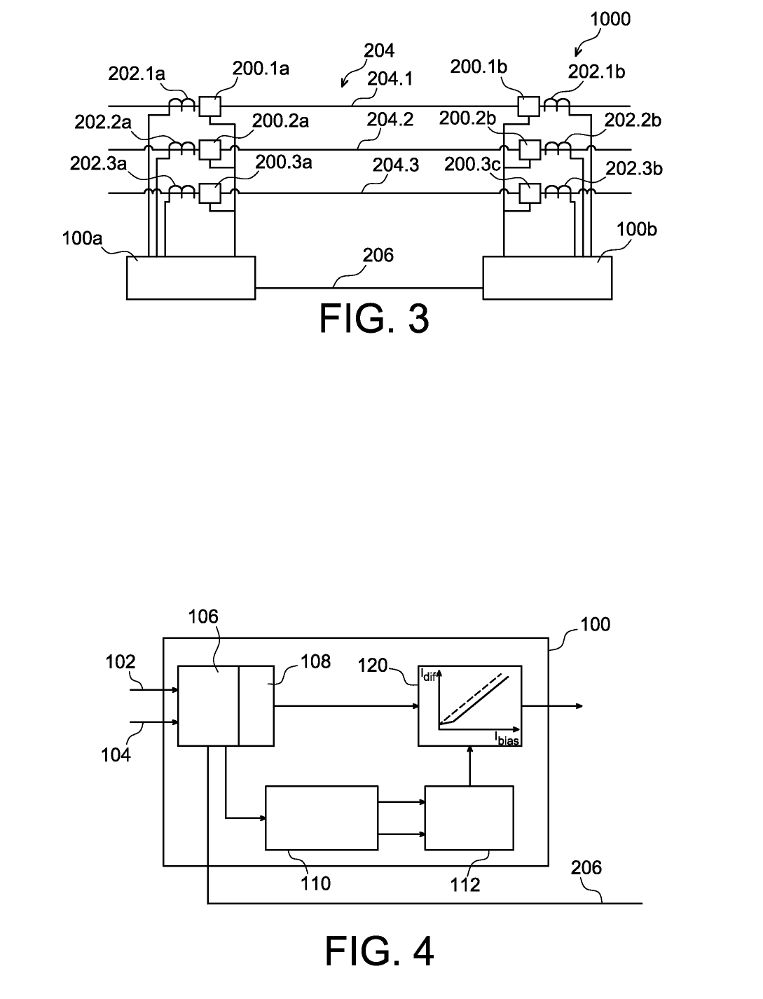

FIG. 3 shows a schematic view of a current differential protection system 1000 according to a particular embodiment. This system comprises two relays 100a, 100b, each being coupled to one end, or terminal, of a transmission line 204 which is the electrical line protected by the system 1000. The coupling is made for each phase 204.1-204.3 of the transmission line 204, here for the three phases of the line 204. Circuit breakers 200.1a-200.3a and 200.1b-200.3b and current transformers (CT) 202.1a-202.3a and 202.1b-202.3b are arranged on each phases 204.1-204.3 of the transmission line 204 and are associated, respectively, with relays 100a and 100b. A communication between the relays 100a and 100b is made by a communication line 206 which is a fiber optic line in this particular embodiment. However, the communication line 206 between the relays 100a, 100b may be of another communication link type, like a multiplexed link for example.

In operation, each current transformer 202.1a-202.3a, 202.1b-202.3b measures line current values at each ends of the protected line 204 and transmits those values to its associated relay 100a, 100b. Each relay 100a, 100b transmits those values to the relay at the other end of the line 204, for each phase 204.1-204.3 of the transmission line 204. Thus, for each phase, each relay 100a, 100b combines the local current iₛ given by the associated current transformers with the remote line current values iᵣ sent from the remote relay.

FIG. 4 shows a schematic view of a relay 100 which corresponds to one of the relays 100a, 100b, according a particular embodiment. The operation of the relay 100 is described below for one phase of the transmission line 204, but it is the same for the other phases of the line 204, for example in a three phases electrical power system like the system 1000 represented in FIG. 3.

The relay 100 comprises a first input 102 for receiving, for each phase, the current iₛ measured by its associated current transformer and a second input 104 for receiving line current values iᵣ from the remote relay at the opposite end of the protected zone of the transmission line 204. The current at each line end may be measured by sampling at a fixed frequency. The data samples represent the instantaneous values of the current waveforms, and may contain dc offset, harmonics and high frequency components.

The signals iₛ and iᵣ are then filtered with a filter 106, which may be a digital filter using the one cycle Fourier filtering technique which yields the power frequency components of the current waveforms in vector form. The vector values of all three phases together with other relevant timing and status information are transmitted over the communication channels to the other ends of the line. This information is considered as remote information for the other(s) relay(s). Based on the local and received vector information, differential currents i_{diff} and bias, or stabilization, currents i_{bias} are calculated by a calculation unit 108 such that, for each phase:

|i_{bias}|=0.5(|iₛ|+|iᵣ|), and

|i_{diff}|=|iₛ+iᵣ|.

The values of iᵣ and iₛ are then used by a first calculator 110 for calculating sequence currents, that is zero sequence currents i₀, positive sequence currents i₁ and negative sequence currents i₂ from the local and remote vector information obtained at the output of the filter 106. The sequence currents are, for the remote vector information:

$${i}_{0} = \frac{1}{3} ( {i}_{ra} + {i}_{rb} + {i}_{rc} )$$

$${i}_{1} = \frac{1}{3} ( {i}_{ra} + {ai}_{rb} + {a}^{2} {i}_{rc} )$$

$${i}_{2} = \frac{1}{3} ( {i}_{ra} + {a}^{2} {i}_{rb} + {ai}_{rc} )$$

with α=1<120°, and iᵣₐ, i_{rb}, i_{rc} which correspond respectively to current at the remote end for each of the three phases a, b and c.

For the local vector information, the sequence currents are:

$${i}_{0} = \frac{1}{3} ( {i}_{sa} + {i}_{sb} + {i}_{sc} )$$

$${i}_{1} = \frac{1}{3} ( {i}_{sa} + {ai}_{sb} + {a}^{2} {i}_{sc} )$$

$${i}_{2} = \frac{1}{3} ( {i}_{sa} + {a}^{2} {i}_{sb} + {ai}_{sc} )$$

with iₛₐ, i_{sb}, i_{sc} which correspond respectively to local current of each of the three phases a, b and c.

These sequence currents are then used by the first calculator 110 to obtain the value of a first combination signal i₁₂:

i₁₂=i₂−k_{1g}i₁

i₁₂ is the combination of the negative sequence current i₂ with the positive sequence current i₁. In this combination, the negative sequence current i₂ always appear, while the positive sequence current is only subtracted with adequate coefficient k_{1g} when a three-phase fault occurs. Indeed, for symmetrical faults (that is when the current amplitude in each phase is higher than or equal to around 1.5 per unit in any phase), k_{1g} is equal to zero. Otherwise, the value of k_{1g} is chosen non-zero, and, for example, equal to 6.

A second combination signal i₀₁₂ is also calculated by the second calculator 110:

i₀₁₂=k₂ₚi₂+k_{1g}(i₁+i₀)

Thus, compared with i₁₂, i₀₁₂ is enriched with zero sequence current to improve detecting ground faults. Calculation of combination signals is initiated when the bias current is greater than or equal to 1.5 per unit in any phase. Indeed, like k_{1g}, for symmetrical faults, k₂ₚ is equal to zero. Otherwise, the value of k₂ₚ is chosen non-zero, and, for example, equal to 6.

The combination signals i₁₂ and i₀₁₂ are calculated for all sequence currents previously calculated, that is from the local and remote vector information.

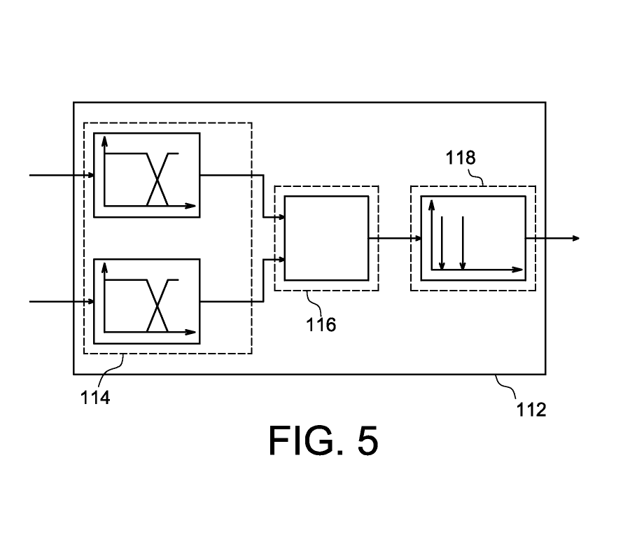

Then the values of phase differences φ₁₂ and φ₀₁₂ between the combination signals i₁₂ and i₀₁₂ are calculated by a second calculator (which is the first calculator 110 in the example represented in FIG. 5) and outputted from the calculator 110 to a fuzzy inference system 112.

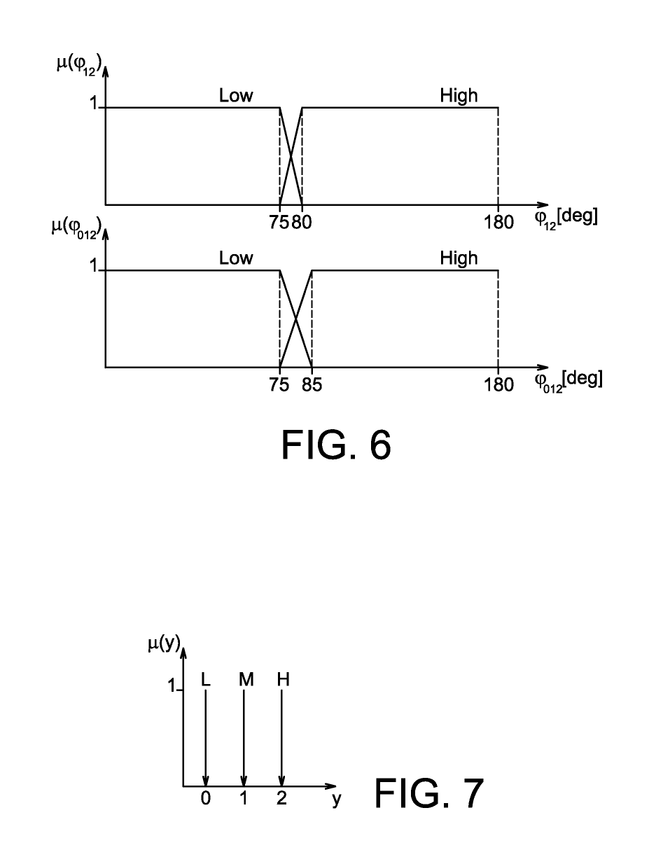

FIG. 5 shows a block diagram of the fuzzy inference system 112, which comprises three main units. A first unit 114 is a fuzzyfication unit which converts the input variables, that is φ₁₂ and φ₀₁₂, into fuzzy variables μ(φ₁₂) and μ(φ₀₁₂) with use of trapezoidal membership functions as represented on FIG. 6.

Thus, when the value of φ₁₂ is included between 0° and 75°, μ(φ₁₂) is “Low” with a value equal to 1 and “High” with a value equal to 0. When the value of φ₁₂ is included between 80° and 180°, then μ(φ₁₂) is “Low” with a value equal to 0 and “High” with a value equal to 1. When the value of φ₁₂ is included between 75° and 80°, μ(φ₁₂) is “Low” with a value equal to

$$1 - \frac{{ϕ}_{12} - 75}{5}$$

and “High” with a value equal to

$$\frac{{ϕ}_{12} - 75}{5} .$$

When the value of φ₀₁₂ is included between 0° and 75°, μ(φ₀₁₂) is “Low” with a value equal to 1 and “High” with a value equal to 0. When the value of φ₀₁₂ is included between 85° and 180°, μ(φ₀₁₂) is “Low” with a value equal to 0 and “High” with a value equal to 1. When the value of φ₀₁₂ is included between 75° and 85°, μ(φ₀₁₂) is “Low” with a value equal to

$$1 - \frac{{ϕ}_{012} - 75}{10}$$

and “High” with a value equal to

$$\frac{{ϕ}_{012} - 75}{10} .$$

Although trapezoidal membership functions are used in this embodiment, other types of membership functions may be used to convert phase differences into fuzzy variables (S-shaped, sigmoidal, Z-shaped, triangular membership functions, . . . ).

Then, a second unit 116, which is an inference operation unit, performs an inference operation on fuzzy variables μ(φ₁₂) and μ(φ₀₁₂) to obtain final fuzzy sets μ(y). In this embodiment, the fuzzy rules base used by the second unit 116 is composed of three statements:

IF φ₀₁₂ is “High” AND φ₁₂ is “High” THEN μ(y) is “L”;

IF φ₀₁₂ is “Low” AND φ₁₂ is “High” OR φ₀₁₂ is “High” AND φ₁₂ is “Low” THEN μ(y) is “M”;

IF φ₀₁₂ is “Low” AND φ₁₂ is “Low” THEN μ(y) is “H”;

with “L”, “M” and “H” which are singletons corresponding to output values 0, 1 and 2 respectively. (see FIG. 7 which represents the final fuzzy sets).

The inference method used with the fuzzy rules base may be the PROD-MAX method, in which the operators “Product” and “Maximum” represent the logical functions “AND” and “OR”, respectively. However, other inference methods, like MAX-MN (in which the operators “Minimum” and “Maximum” represent the logical functions “AND” and “OR”) or SUM-PROD (in which the operators “Sum” and “Product” represent the logical functions “OR” and “AND”) can be used.

Finally, a third unit 118 performs a defuzzyfication operation which converts the final fuzzy sets μ(y) back to respective crisp values by the use of a weighting factor method, the resulting crisp value being expressed by:

$$y = \frac{{μ}_{L} {y}_{L} + {μ}_{M} {y}_{M} + {μ}_{H} {y}_{H}}{{μ}_{L} + {μ}_{M} + {μ}_{H}} ,$$

with

μ_{L}=1 when y=0, and μ_{L}=0 otherwise;

μ_{M}=1 when y=1, and μ_{M}=0 otherwise;

μ_{H}=1 when y=2, and μ_{L}=0 otherwise.

The value y obtained at the output of the fuzzy inference system 112 is then used by a third calculator 120 of the relay 100 to calculate the values of bias percentages k₁ and k₂ of a stabilized characteristic:

k₁=0.3+0.8y when the parameter y is higher than around 1.5, and k₁=0.3 otherwise;

k₂=1.5+1.6y.

Thus the tripping conditions of the relay 100 are:

For |i_{bias}|<I_{S2}, tripping when |i_{diff}|>k₁|i_{bias}+I_{S1};

For |i_{bias}|>I_{S2}, tripping when |i_{diff}|>k₂|i_{bias}−(k₂−k₁)I_{S2}+I_{S1};

with I_{S1}=0.3 and I_{S2}=2.

1. A relay for current differential protection of at least one transmission line, comprising at least:
a first calculator of symmetrical sequence currents, which include zero sequence currents i₀, positive sequence currents i₁ and negative sequence currents i₂, of currents of each phase of the transmission line at local and remote ends of the protected transmission line;
a second calculator of phase differences φ₁₂ and φ₀₁₂ between combinations currents i₁₂ and i₀₁₂ of the symmetrical sequence currents i₀, i₁ and i₂ of each ends of the transmission line;
a fuzzy inference system which outputs a variable y whose value is calculated according to the values of the phase differences φ₁₂ and φ₀₁₂;
a third calculator which outputs a tripping signal for the control of at least one circuit breaker arranged on the transmission line and associated with the relay, the value of the tripping signal being calculated according to the values of the variable y and the values of the currents of each phase of the transmission line at the local and remote ends of the protected transmission line.

2. The relay according to claim 1, wherein the combination currents i₁₂ and i₀₁₂ are such that:
i₁₂=i₂−k_{1g}i₁;
i₀₁₂=k₂ₚi₂+k_{1g}(i₁+i₀);
with k_{1g}=k₂ₚ=0 when the current amplitude in each phase is higher than or equal to around 1.5 per unit in any phase, and k_{1g} and k₂ₚ being non-zero real numbers otherwise.

3. The relay according to claim 1, wherein the fuzzy inference system comprises at least:
a fuzzyfication unit which converts the values of the phase differences φ₁₂ and φ₀₁₂ into fuzzy variables μ(φ₁₂) and μ(φ₀₁₂);
an inference operation unit which performs inference operation on fuzzy variables μ(φ₁₂) and μ(φ₀₁₂) according to a fuzzy rules base and outputs final fuzzy sets μ(y) as a result of said inference operation;
a defuzzyfication unit which converts the final fuzzy sets μ(y) into the variable y by a defuzzyfication operation.

4. The relay according to claim 3, wherein the fuzzyfication unit converts the phase difference μ₁₂ into the fuzzy variable μ(φ₁₂) such that:
when the value of φ₁₂ is included between 0° and 75°, μ(φ₁₂) is “Low” with a value equal to 1 and “High” with a value equal to 0;
when the value of φ₁₂ is included between 80° and 180°, μ(φ₁₂) is “Low” with a value equal to 0 and “High” with a value equal to 1;
when the value of φ₁₂ is included between 75° and 80°, μ(φ₁₂) is “Low” with a value equal to
$$1 - \frac{{ϕ}_{12} - 75}{5}$$
and “High” with a value equal to
$$\frac{{ϕ}_{12} - 75}{5} .$$

5. The relay according to claim 3, wherein the fuzzyfication unit converts the phase difference φ₀₁₂ into the fuzzy variable μ(φ₀₁₂) such that:
when the value of φ₀₁₂ is included between 0° and 75°, μ(φ₀₁₂) is “Low” with a value equal to 1 and “High” with a value equal to 0;
when the value of φ₀₁₂ is included between 85° and 180°, μ(φ₀₁₂) is “Low” with a value equal to 0 and “High” with a value equal to 1;
when the value of φ₀₁₂ is included between 75° and 85°, μ(φ₁₂) is “Low” with a value equal to
$$1 - \frac{{ϕ}_{012} - 75}{10}$$
and “High” with a value equal to
$$\frac{{ϕ}_{012} - 75}{10} .$$

6. The relay according to claim 3, wherein the inference operation unit performs the inference operation according to the following fuzzy rules base:
IF φ₀₁₂ is “High” AND φ₁₂ is “High” THEN y is “L”;
IF φ₀₁₂ is “Low” AND φ₁₂ is “High” OR φ₀₁₂ is “High” AND φ₁₂ is “Low” THEN y is “M”;
IF φ₀₁₂ is “Low” AND φ₁₂ is “Low” THEN y is “H”;
with “L”, “M” and “H” which are singletons corresponding to output values 0, 1 and 2 respectively.

7. The relay according to claim 6, wherein the logical functions “AND” and “OR” of the fuzzy rules base correspond to operators “Product” and “Maximum” respectively.

8. The relay according to claim 3, wherein the defuzzyfication operation is a weighting factor method, the resulting output value y being expressed by:
$$y = \frac{{μ}_{L} {y}_{L} + {μ}_{M} {y}_{M} + {μ}_{H} {y}_{H}}{{μ}_{L} + {μ}_{M} + {μ}_{H}} ,$$
with
μ_{L}=1 when y=0, and μ_{L}=0 otherwise;
μ_{M}=1 when y=1, and μ_{M}=0 otherwise;
μ_{H}=1 when y=2, and μ_{L} =0 otherwise.

9. The relay according to claim 1, wherein the third calculator calculates values of bias percentages k₁ and k₂ of a stabilized characteristic which corresponds to the tripping signal such that:
k₁=0.3+0.8y when the parameter y is higher than around 1.5, and k₁=0.3 otherwise;
k₂=1.5+1.6y;
the tripping conditions of the circuit breaker being:
for |i_{bias}|<I_{S2}, tripping when |i_{diff}|>k₁|i_{bias}|+I_{S1};
for |i_{bias}|>I_{S2}, tripping when |i_{diff}|>k₂|i_{bias}|−(k₂−k₁)I_{S2}+I_{S1};
with, for each phase of the transmission line:

|i_{bias}|=0.5(|iₛ|+|iᵣ|), and

|i_{diff}|=|iₛ+iᵣ|, with
iₛ: current at the local end of the protected transmission line;
iᵣ: current at the remote end of the protected transmission line;
I_{S1}, I_{S2}: non-zero positive real numbers.

10. A current differential protection method of at least one transmission line, comprising at least the steps of:
calculating symmetrical sequence currents, which include zero sequence currents i₀, positive sequence currents i₁ and negative sequence currents i₂, of currents of each phase of the transmission line at local and remote ends of the protected transmission line;
calculating phase differences φ₁₂ and φ₀₁₂ between combination currents i₁₂ and i₀₁₂ of the symmetrical sequence currents i₀, i₁ and i₂ of each ends of the transmission line;
applying a fuzzy inference method on the phase differences φ₁₂ and φ₀₁₂, outputting a variable y whose value is calculated according to the values of the phase differences φ₁₂ and φ₀₁₂;
calculating a value of a tripping signal for the control of at least one circuit breaker arranged on the transmission line according to the values of the variable y and the values of the currents of each phase at the local and remote ends of the protected transmission line.

11. The method according to claim 10, wherein the combination currents i₁₂ and i₀₁₂ are such that:
i₁₂=i₂−k_{1g}i₁;
i₀₁₂=k₂ₚi₂+k_{1g}(iₗ+i₀);
with k_{1g}=k₂ₚ=0 when the current amplitude in each phase is higher than or equal to around 1.5 per unit in any phase, and k_{1g} and k₂ₚ being non-zero real numbers otherwise.

12. The method according to claim 10, wherein the fuzzy inference method comprises at least the steps of:
fuzzyfication operation which converts the values of the phase differences φ₁₂ and φ₀₁₂ into fuzzy variables μ(φ₁₂) and μ(φ₀₁₂);
inference operation on fuzzy variables μ(φ₁₂) and μ(φ₀₁₂) according to a fuzzy rules base to output a final fuzzy sets μ(y);
defuzzyfication operation which converts the final fuzzy sets μ(y) into the variable y.

13. The method according to claim 12, wherein the fuzzyfication operation converts the phase difference φ₁₂ into the fuzzy variable μ(φ₁₂) such that:
when the value of φ₁₂ is included between 0° and 75°, μ(φ₁₂) is “Low” with a value equal to 1 and “High” with a value equal to 0;
when the value of φ₁₂ is included between 80° and 180°, μ(φ₁₂) is “Low” with a value equal to 0 and “High” with a value equal to 1;
when the value of φ₁₂ is included between 75° and 80°, μ(φ₁₂) is “Low” with a value equal to
$$1 - \frac{{ϕ}_{12} - 75}{5}$$
and “High” with a value equal to
$$\frac{{ϕ}_{12} - 75}{5} .$$

14. The method according to claim 12, wherein the fuzzyfication operation converts the phase difference φ₀₁₂ into the fuzzy variable μ(φ₀₁₂) such that:
when the value of φ₀₁₂ is included between 0° and 75°, μ(φ₀₁₂) is “Low” with a value equal to 1 and “High” with a value equal to 0;
when the value of φ₀₁₂ is included between 85° and 180°, μ(φ₀₁₂) is “Low” with a value equal to 0 and “High” with a value equal to 1;
when φ₀₁₂ is included between 75° and 85°, μ(φ₁₂) is “Low” with a value equal to
$$1 - \frac{{ϕ}_{012} - 75}{10}$$
and “High” with a value equal to
$$\frac{{ϕ}_{012} - 75}{10} .$$

15. The method according to claim 12, wherein the inference operation is performed according to the following fuzzy rules base:
IF φ₀₁₂ is “High” AND φ₁₂ is “High” THEN y is “L”;
IF φ₀₁₂ is “Low” AND φ₁₂ is “High” OR φ₀₁₂ is “High” AND φ₁₂ is “Low” THEN y is “M”;
IF φ₀₁₂ is “Low” AND φ₁₂ is “Low” THEN y is “H”;
with “L”, “M” and “H” which are singletons corresponding to output values 0, 1 and 2 respectively.

16. The method according to claim 15, wherein the logical functions “AND” and “OR” of the fuzzy rules base correspond to operators “Product” and “Maximum” respectively.

17. The method according to claim 12, wherein the defuzzyfication operation is a weighting factor method, the resulting output value y being expressed by:
$$y = \frac{{μ}_{L} {y}_{L} + {μ}_{M} {y}_{M} + {μ}_{H} {y}_{H}}{{μ}_{L} + {μ}_{M} + {μ}_{H}} ,$$
with
μ_{L}=1 when y=0, and μ_{L}=0 otherwise;
μ_{M}=1 when y=1, and μ_{M}=0 otherwise;
μ_{H}=1 when y=2, and μ_{L}=0 otherwise.

18. The method according to claim 10, wherein the values of bias percentages k₁ and k₂ of a stabilized characteristic which corresponds to the tripping signal are calculated such that:
k₁=0.3+0.8y when the parameter y is higher than around 1.5, and k₁=0.3 otherwise;
k₂=1.5+1.6y;
the tripping conditions of the circuit breaker being:
for |i_{bias}|<I_{S2}, tripping when |i_{diff}|>k₁|i_{bias}|+I_{S1};
for |i_{bias}|>I_{S2}, tripping when |i_{diff}|>k₂|i_{bias}|−(k₂−k₁)I_{S2}+I_{S1};
with, for each phase of the transmission line:

|i_{bias}|=0.5(|iₛ|+|iᵣ|) and

|i_{diff}|=|iₛ+iᵣ|, with
iₛ: current at the local end of the protected transmission line;
iᵣ: current at the remote end of the protected transmission line;
I_{S1}, I_{S2}: non-zero positive real numbers.

19. A current differential protection system comprising at least two relays according to claim 1, each being coupled to one end of a transmission line and linked to the each other with communication means.
